(19) United States
(12) Patent Application Publication
(10) Pub. No.: US 2002/0178097 A1
(43) Pub. Date: Nov. 28, 2002

(54) Lunar and planetary land property allocation method and system

(76) Inventor: Frank J. Snow, Locust Grove, VA (US)

Correspondence Address: FRANK J. SNOW, 303 SPOTSWOOD ROAD, LOCUST GROVE, VA, 22508, US

(21) Appl. No.: 10/051,000

(22) Filed: Jan. 22, 2002

Related U.S. Application Data
(60) Provisional application No. 60/264,731, filed on Jan. 30, 2001.

(51) Int. Cl. G06F 17/60

(52) U.S. Cl. 705/35

(57) ABSTRACT

A method and system for allocating parcels of land property located on a planetary body such as the Moon, such parcels being sub-divisions of extensive parts of land on the planetary body that have previously been subjected to government sponsored manned spacecraft landings and the subsequent site explorations and surveys. Such explorations, when survey-referenced to well-defined manned-spacecraft landing sites, provide the potential for a government to claim extensive parts of land and subsequently exercise an option to grant parcels to individuals for the purpose of encouraging government-beneficial land development. The availability of manned-landing site survey reference points enables sub-division of the land into parcels whose individual locations and boundaries can be precisely defined in a land grant. Individual requests for land parcels to be granted by the government would be expected to be more likely to be approved when such claims are supported by a document, to be called a Deed of Claim, which includes a precise location and boundary description of the requested parcel. This method and system provide for both the sub-division of a large area of land into parcels by a primary business entity, the parcels being precisely described in terms of location and boundary with respect to a government survey reference position; and the subsequent offer for sale of a Deed Of Claim incorporating such a description to individuals wanting to own a parcel description in anticipation of requesting a government-provided grant of the parcel on the basis of owning the Deed Of Claim.

### CROSS-REFERENCE TO RELATED APPLICATION

This application claims the benefit of a Provisional Patent Application identified as follows:

U.S. application Ser. No. 60/264,731 FILING DATE: Jan. 30, 2001

NAME OF APPLICANT: Frank J. Snow

TITLE OF INVENTION: Lunar and planetary land property allocation method and system.

### FIELD OF THE INVENTION

The present invention generally relates to methods and systems for lunar and other planetary land property information access, and more specifically, to methods and systems for compiling information about a planetary land property entity on a computer-readable storage medium using a computer or other like programmable apparatus.

1. Background of the Invention

There have been efforts involving the novelty sales of lunar land. The approach used has been to make reference to the U.S.A. as not being a signatory to the United Nations Moon Treaty of 1979, which states that no nation or person can own lunar land, and, to make reference to the U.S.A. Homestead Act of 1862, which enabled U.S. citizens to claim and subsequently obtain land grants in western territorial lands.

Such efforts are typically based on the seller's position that the above U.S.A. precedent of not signing the treaty therefore enables the seller to claim ownership of the Moon and subsequently offer the sales of lunar land to interested parties. The “Lunar Deed” provided by the seller to a buyer may have a notation in the bottom left of the “Lunar Deed” stating “This is a novelty gift”.

The result is that such sales efforts do recognize that they have no legal basis for the ownership and subsequent sales of lunar land, and that the “Lunar Deeds” sold are only intended to serve as a novelty gift, i.e., such deeds are for entertainment value only and are not in any way intended to serve or have the potential to serve as a legal basis for the acquisition of lunar land property.

The present invention covers a new and different type of sales effort related to the acquisition of lunar land property, i.e., the sales of Deeds of Claim for individual lunar land parcels based on U.S. human exploration of specific lunar land areas. Such Deeds of Claim have a potential for legal merit as they are based on the fact that the U.S. Apollo Program resulted in six (6) manned lunar landings.

The landings resulted in the first human exploration of the Moon by the U.S.A. and the establishment of a well-defined land survey reference point at each exploration-landing site. This program does provide a basis for the potential future exercise of a claim of extensive lunar land ownership by the U.S. Government. It follows that a historical consequence of such ownership by the U.S.A. is the enabling of the government to later grant land parcels to individuals in order to foster land and related economic development.

It may then be anticipated that the existence of a prior Deed of Claim to a precise and well-defined description of the location and boundaries of the parcel of land could provide a potentially strong legal basis for U.S. Government conversion of each “Deed of Claim” to a “Deed of Ownership” for the designated lunar land parcel. The validity of this method of business for offering for sale a Deed of Claim to each individual parcel of lunar land is further based on the use of survey boundary descriptions that can be well defined, i.e., can be precisely referenced to the six (6) Apollo Landing Sites.

An example of the potential for easily conducting precise land parcel surveys on the Moon is in the use of laser distance measurement devices and techniques that enable land surveys of better than one foot accuracy for distances, from reference location sites, of up to and in excess of hundreds of miles (the high accuracy of measurement due in part to the absence of an atmosphere on the Moon).

As a result, parcels of lunar land property having precisely defined boundary locations could be made available for sale in the form of Deeds of Claim. Such deeds would necessarily include the statement that the deed does not immediately convey ownership of the described parcel of land to the deed owner, but that the Deed of Claim can serve to provide a potentially strong legal basis for claiming ownership of the subject parcel at such time that the U.S. Government exercises its own rights to lunar territorial ownership.

Such U.S.A rights would be based upon the prior U.S. Apollo Program of manned lunar surveys and explorations, and would subsequently serve as a basis for making land parcels available for individual development by the owners of the land. It could be anticipated that such grants could additionally include: air space rights, land surface rights, and sub-surface rights, including all water, mineral, oil and gas extraction rights.

2. Prior Art

There are many known methods and systems for providing and utilizing a database of real estate properties.

U.S. Pat. No. 5,794,216 to Brown discloses a device for storing information about a plurality of houses for access by an application program executed on a computer or other like programmable apparatus. The device comprises a computer-readable storage medium and computer-readable data on the computer-readable storage medium. Information available for storage and display includes text and imagery for relatable interior and exterior views of each of the houses.

U.S. Pat. No. 5,235,680 to Bijnagte discloses a multimedia database system for maintaining a database containing listings of real estate properties on the market. The system is capable of storing, retrieving, displaying, printing and manipulating color images stored in the database. Further, the system is capable of loading digitized images from remote terminals over telephone lines on an interactive basis. The system includes a multi-user host computer and a plurality of remote data terminals connected to the host computer.

U.S. Pat. No. 5,146,548 to Bijnagte discloses a method and an apparatus for publishing listings of real estate properties. The method includes a step of converting photographed or videotaped images of real estate properties to digital graphics at a front end of a publishing process. Image operations, such as sizing, cropping, and digital quality enhancement are performed when the images are captured.

U.S. Pat. Nos. 5,032,989 and 4,870,576 to Tornetta disclose systems having computer software for creating and maintaining a real estate property database, and for searching the database. Remote seller systems provide property information to a host system. The host system maintains a database of the property information provided thereto. A graphical locator interface allows the database to be searched using search location boundaries.

### SUMMARY OF THE INVENTION

The land grant precedent of the U.S.A. forms the basis of a business method and its related implementation system, wherein a business entity takes the initiative to identify and define boundaries for a multiplicity of lunar territories, the bounds of such territories being referenced to the locations of the Apollo landing sites. The business entity then defines and prepares survey descriptions of land parcel subdivisions of such territories for the purpose of subsequently preparing a Deed of Claim for each land parcel. A Deed of Claim is here defined as a land parcel location and boundary description that has the potential for being used as a basis for establishing a claim for lunar property and its related rights at such time that the Government may exercise the option to grant such parcels to claimant individuals.

The potential value of a Deed of Claim to an individual having an interest in owning a parcel of land on a planetary body at some future time is, therefore, the basis of a method of doing business whereby Deeds of Claim are offered for sale by a business entity to interested individuals. Both pre-sale information and post-sale documentation provided to interested individuals are to make clear the fact that an acquired Deed of Claim for a specifically described planetary land parcel is not intended to serve as evidence of land parcel ownership, but only as evidence of a claim for the described parcel that would be available for potential future application as part of a grant request.

In order for the business entity to offer such Deeds of Claim for land parcels, the business entity initially establishes itself as the owner of a Deed of Claim for a total area of land that is to be subsequently subdivided into land parcels. Each of the total land areas to be subsequently subdivided into parcels has the attribute of containing within its large-area boundary the site of at least one manned spacecraft exploration site.

### BRIEF DESCRIPTION OF THE DRAWINGS

The present invention is illustrated by way of example and not limited to the figures of the accompanying drawings within which like references indicate similar elements and in which:

FIG. 1 illustrates a system for compiling information about a planetary land property to form a database and for querying the database;

FIG. 2 is a flow chart of a method of compiling information about a planetary land property on a computer-readable storage medium,

FIG. 3 illustrates a method of subdivision of lunar land property into regions, shown with respect to the Near Side of the Moon.

FIG. 4 illustrates a method of subdivision of lunar land property into regions, shown with respect to the Far Side of the Moon.

FIG. 5 illustrates a method of subdivision of lunar land property into regions, shown with respect to the Lunar North Pole.

FIG. 6 illustrates a method of subdivision of lunar land property into regions, shown with respect to the Lunar South Pole.

FIG. 7 illustrates a method of subdivision of Region 1 into sections of property.

FIG. 8 illustrates a method of subdivision of a section of Region 1 into blocks of property.

FIG. 9 illustrates a method of subdivision of a block of property in a section of Region 1 into lunar land property parcels.

FIG. 10 illustrates a method of subdivision of a block of property in a section of a Polar Region into lunar land property parcels.

FIG. 11 indicates the content and format of a Deed of Claim.

### BEST MODE FOR CARRYING OUT THE INVENTION

The method of business and its associated means of system implementation for offering Deeds of Claim for planetary land parcels for sale to individual purchasers includes the following process elements:

Identifying a subject planetary body and its manned exploration sites.

Obtaining map and photographic imagery that include the subject body.

Reviewing the imagery and defining at least three levels of imagery range

Developing the imagery in both paper and computer media form.

Selecting boundaries for large land areas containing the exploration sites.

Defining the land area boundaries precisely in terms of latitude and longitude.

Subdividing each of the land areas into land parcels of a selected shape and size.

Defining the land parcel boundaries precisely in terms of latitude and longitude.

Assembling the map and photographic boundary data in computer media form.

Defining a system of land parcel identification for inventory and sales control.

Defining a format for computer display of imagery at the three magnification levels.

Defining a format for operator selection of data presentation and media generation.

Defining a size, form and textual content of a Deed of Claim document.

Incorporating land parcel size and precise boundary coordinates data into the deed.

Incorporating definition of the Deed of Claim utility and bounds into the deed.

Defining a deed document design suitable for computer generation.

Defining the contents of a sample deliverable-to-a-buyer package.

Including in the buyer's package, for example, the following content elements:

A cover letter addressed to the buyer of the Deed Of Claim.

A complete list of the package enclosures.

The Deed of Claim.

A photograph of the planetary body.

A photograph of the explored land area vicinity.

A photograph providing a close-up of the land parcel site.

A map of the planetary body.

A map of the explored land area vicinity.

A map providing precise parcel boundary location details.

Defining a computer-based format for relating land parcels to deed buyers.

Defining a computer-based format for maintaining a deed buyer database.

Selecting and establishing one or more package delivery sources.

Defining the format and content (text and graphics) of an internet web site.

Establishing an internet web site.

Establishing incorporation of the web site into a plurality of search engines.

Defining the method of accepting web viewer intent to purchase.

Defining the method of accepting buyer identification and address.

Defining the method of accepting and verifying buyer payment.

Defining the method of accepting a buyer's ship-to address.

Defining the method of selection of a land parcel.

Identifying the reference manned spacecraft landing site location for the land parcel.

Identifying the selected land parcel location and boundaries.

Defining the data base format for assembling buyer's package information.

Defining the method of computer generation of a buyer's package shipping label.

Defining the method of computer generation of a specific Deed of Claim document.

Defining the method of generating a transmittal letter to a buyer.

Defining the method of generating a deed-explanation letter to the buyer.

Defining the method of parcel-allocation and remaining parcel-inventory control.

It is an object of the present system invention to provide a database of multimedia information, such as multimedia planetary land property information, having various types of information, such as text, graphics and images, compiled in a single database format.

Another object of the present invention is to provide a method and system for compiling multimedia information, such as multimedia planetary land property information, into a single database format.

In carrying out the above objects, the present invention provides a device for storing information about a plurality of planetary land parcels for access by an application program executed on a computer or other like programmable apparatus. The device comprises a computer-readable storage medium and computer-readable data on the computer-readable storage medium. The computer-readable data is representative of a database containing textual information for each planetary land property, at least one large area image for each planetary and property, at least one local area image for each planetary land property, and at least one parameter indicating a portion of the large area image corresponding to the local area image for each planetary land property, all in a common database format.

Further, in carrying out the above objects, the present invention provides a method of compiling information about a planetary land property on a computer-readable storage medium using an apparatus having a processor and a memory. The method comprises receiving textual information for the planetary land property, receiving a large area image of the planetary land property, receiving a local area image of the planetary land property, and receiving at least one parameter indicating a portion of the large area image corresponding to the local area image.

The method further includes compiling the textual information, the at-least one large area image, the-at least one local area image, and the at-least one parameter into a computer-readable database with a single database format on the computer-readable storage medium.

Still further, in carrying out the above objects, the present invention provides a system, in accordance with the above-described method, for compiling information about a planetary land property on a computer-readable storage medium using a computer or other like programmable apparatus having a processor and a memory.

By compiling the various types of multimedia information into a single database format, embodiments of the present invention are advantageous over the prior art with regard to ease of management and ease of communication of the multimedia information.

These and other features, aspects, embodiments, and advantages of the present invention will become better understood with regard to the following description, appended claims, and accompanying drawings.

Embodiments of the present invention include a data acquisition computer program for compiling information for each of a plurality of planetary land properties into a database, and a viewer program for accessing the database. The data acquisition program allows a user to compile pictures, data, and view feature information in a single database format using a drag-and-drop user interface.

In a preferred embodiment of a planetary land property selection application, all information about a planetary land property is stored as a single record in the database. This record includes: imagery, view feature coordinates and picture identifiers for each view interest, and textual information to be displayed to the user. Each of the view features are created by dragging a rectangle over a portion of the planetary land property, and then dragging and dropping an image into the rectangle.

The viewer program allows the user to query the database assembled by the data acquisition program. The results of the query function in an event driver, interactive environment.

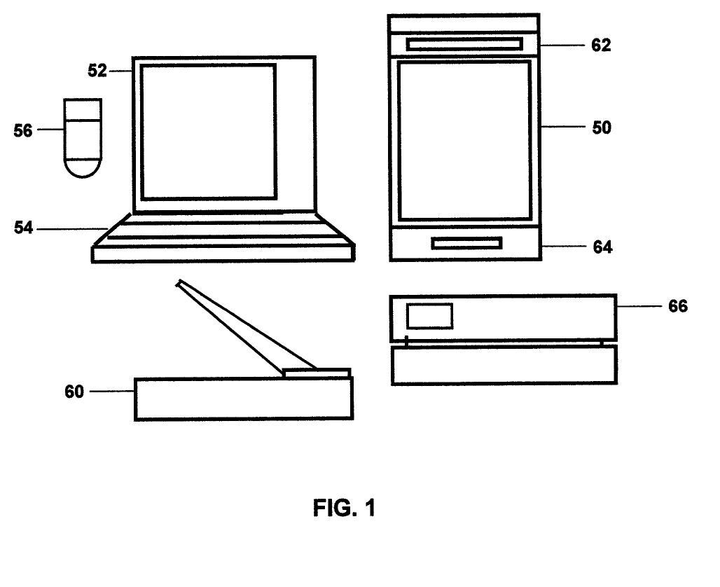

Turning now to FIG. 1, there is shown a system for compiling information about a planetary land property to form a database, and for querying the database. The system includes a computer 50 or other like programmable apparatus having a processor and a memory (not specifically illustrated). For example, the computer 50 may be an IBM compatible PC, a Macintosh compatible PC, a Power PC compatible computer, etc. It should be apparent, though, that other types of computers with different specifications could be employed.

The computer 60 communicates with a display device 52, such as a computer monitor. The computer 50 also communicates with one or more input devices, such as a keyboard 54 and a mouse 56. The mouse 56 is used to click on icons displayed on the display device 52, and to perform click-drag-and-drop operations.

The computer 50 receives image information by means of a page scanner 60, a compact disk drive 62, a floppy disk drive 64, or a modem (not specifically illustrated). Other input devices may be used to provide image information to the computer 50, such as a video camera, a digital camera, or a fax. The computer 50 is optionally coupled to a printer 66 to produce hard copy displays of various types of information contained in the computer 50.

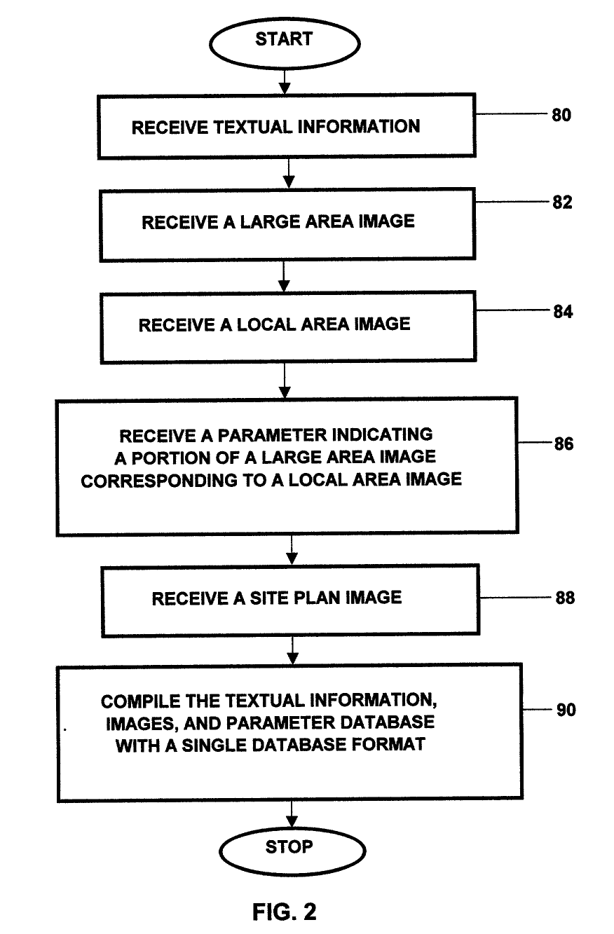

Turning now to FIG. 2, there is shown a flow chart of a method of compiling information about a planetary land property on a computer-readable storage medium. Examples of the computer-readable storage medium include, but are not limited to, magnetic floppy disks, magnetic tapes, optical disks (such as a CD ROM), a static memory, or a dynamic memory.

As indicated by block 80, the method includes receiving textual information for the planetary land property. The textual information may be received by any of the peripherals connected to the computer 50. For example, some of the textual information may be entered using the keyboard 54 and the mouse 56.

In a preferred embodiment, the receipt of the textual information for the planetary land property is performed by the display of a data entry template on the display device 52. The data entry template contains a plurality of fields, wherein each of the fields corresponds to a different piece of textual information to be received. A signal is then received to select one of the fields.

The signal may be generated by a point-and-click operation performed by the mouse 56, or a selection operation performed using the keyboard 54, for example. Next, textual data for the selected one of the fields is received. This textual data may be entered using the keyboard 54. Alternatively, the textual information may be entered using an existing textual database, or the page scanner 60 in conjunction with an optical character recognition software program.

The method further includes receiving a large area image of the planetary land property, as indicated by block 82. In a preferred embodiment, a plurality of large area images of the planetary land property is received. The plurality of large area images may include, for example, a first large area view of the planetary land property and a second large area view of the planetary land property.

As indicated by block 84, the method includes receiving a local area image of the planetary land property. Preferably, a plurality of local area images of the planetary land property is received. The local area images preferably include images of other features contained within the planetary land property.

The local area and large area images of the planetary land property are received by any of the peripherals connected to the computer 50. Specifically, the images may be received from a hard copy representation using the page scanner 60. If the images are in an electronic format, they can be received using the modem. If the images are in a magnetic format, they can be received using the floppy disk drive 64 or a tape drive. Alternatively, if the images are on an optical compact disk, they may be received using the compact disk drive 62. Images can also be formed using a video camera, digital camera, or a fax.

As indicated by block 86, the method further includes receiving at least one parameter indicating a portion of the large area image corresponding to one of the local area images. The portion of the large area image is used to define a view feature, which may be selected by the user using the viewer program described herein.

If a plurality of local area images are received, then receiving the at least one parameter may be performed in the following manner. Receiving a first signal to select one of the pluralities of local area images is performed. The first signal may be generated using either the keyboard 54 or the mouse 56. Next, receiving a second signal to select a portion of the large area image corresponding to the one of the local area images is performed. The second signal is preferably generated by a click and drag operation performed using the mouse 56. The computer 50 then determines a plurality of coordinates, which define the portion of the large area image based upon the second signal.

Optionally, the method further includes receiving a site image of at least a portion of the planetary land property as indicated by block 88. If the planetary land property contains a plurality of site features, then a plurality of site images corresponding to each site feature can be received. View features may also be defined for regions of the site image. Here, a local area image can be assigned to a portion of the site image corresponding to a feature of the planetary land property.

As indicated by block 90, the method includes compiling the textual information, at least one large area image, at least one local area image, and the at least one parameter into a computer-readable database on the computer-readable storage medium. The computer-readable database contains all of this information using a single database format. Preferably, all of the information about a planetary land property is stored as a single record in the database. Here, the information may be stored in a single relational record in a relational database.

Any of a number of different databases may be utilized, such as the Microsoft Access database or the Microsoft SQL server database. In an exemplary embodiment of the present invention described hereinafter, all of the information about the planetary land property is stored in a single file on the computer-readable storage medium. This single file includes binary image information, coordinates and picture identifiers for each view feature, and textual information about the planetary land property.

Although presented in terms of planetary land properties in general, embodiments of the present invention can be used to store information not only about the land properties of the Earth's Moon (Lunar Land Properties) but also for other planetary bodies offering a potential for land acquisition and development, including the planet Mars (Martian Land Properties).

It is also an object of the invention to provide a method of subdivision of a planetary body into four categories of decreasing land area size: region, section, block, and parcel. In this method, a land area boundary consists of lines of Latitude and Longitude, and is defined by the Latitude and Longitude coordinates of boundary corners. The method has a particular advantage when applied to a planetary body such as the Moon because of the availability of lunar maps and photographs that already employ such coordinates, and further, of the U.S. Government's publication of data on the location of the six Apollo manned spacecraft landing sites to a degree-accuracy of four decimal places, i.e., one part in one hundred thousand or, on the Moon, a landing site location accuracy of about one foot.

The credibility of generated property allocation information is significantly enhanced by the knowledge that, on the Moon, a parcel can be easily and precisely located by the use of survey measurement techniques referenced to an Apollo landing site.

The method of subdivision of the planetary land property of an entire planetary body such as Earth's Moon includes the following:

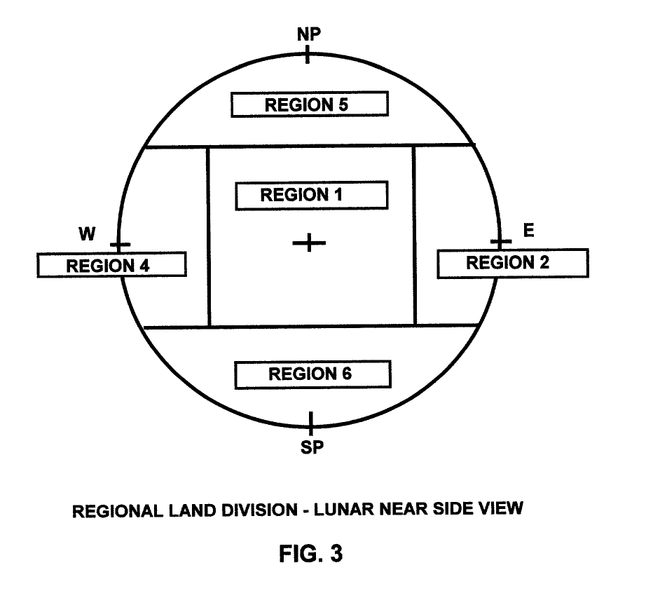

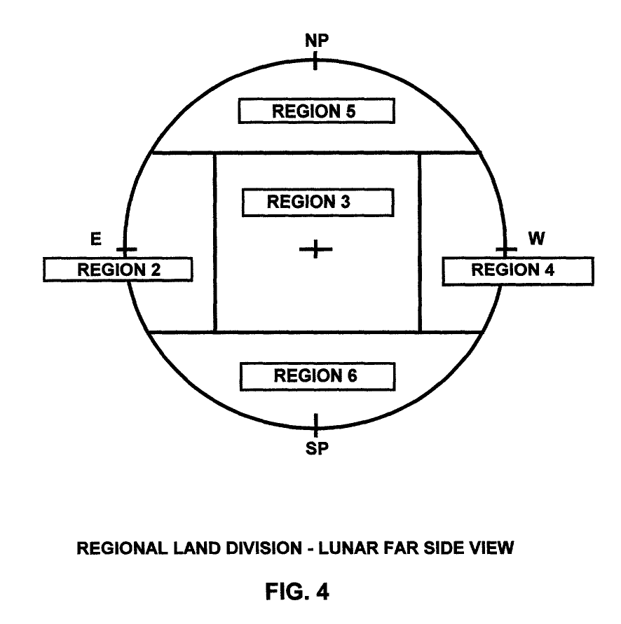

Division of the lunar globe into six regions, see FIGS. 3, 4, 5, and 6, where:

Region 1 is centered on the Earth-facing part (Near Side) of the Moon, bounded by the longitude lines of 315 (West) and 45 (East) degrees, and the latitude lines of plus 45 (North) and minus 45 (South) degrees; and

Region 2 is centered on the Eastern end of the Near Side of the Moon, bounded by the longitude lines of 45 and 135 degrees, and the latitude lines of plus 45 (North) and minus 45 (South) degrees; and

Region 3 is centered on the Far Side of the Moon, bounded by the longitude lines of 135 and 225 degrees, and the latitude lines of plus 45 (North) and minus 45 (South) degrees; and

Region 4 is centered on the Western end of the Near Side of the Moon, bounded by the longitude lines of 225 and 315 degrees, and the latitude lines of plus 45 (North) and minus 45 (South) degrees; and

Region 5, the Lunar North Polar Region, is centered on the Lunar North Pole and includes all land above the latitude line of plus 45 (North) degrees; and

Region 6, the Lunar South Polar Region, is centered on the Lunar South Pole and includes all land below the latitude line of minus 45 (South) degrees; and, further

Division of each region into six sections; where

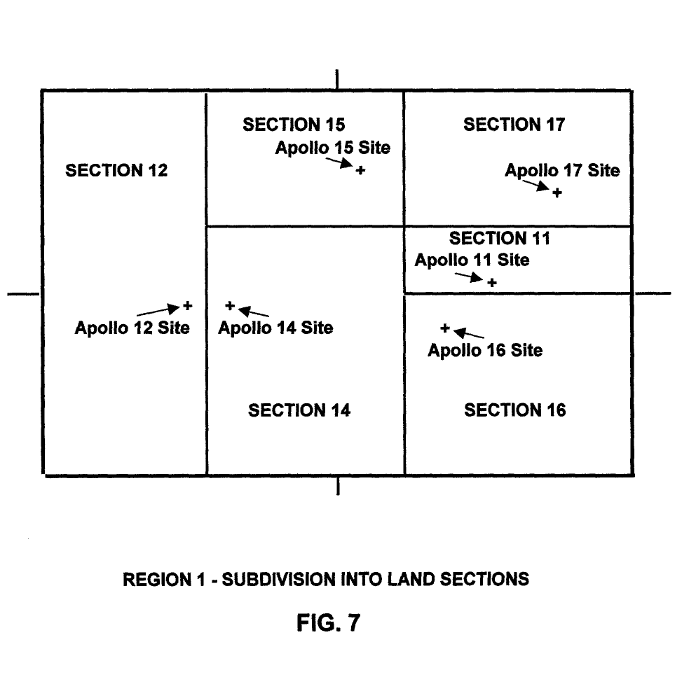

Region 1, see FIG. 7, is divided into six rectangular sections of typically unequal size, each section having the attribute of containing within it's boundary the site of a manned spacecraft landing that resulted from the U.S. Government's Apollo Space Program, in which six landings occurred in the 1969-1972 period; and where the sections are numerically identified by the contained Apollo spacecraft designation, i.e., Sections 11, 12, 14, 15, 16, and 17; and, where the four corner locations (Latitude (first) and Longitude (second), in degrees) of each section of Region 1 are as follows:

| | |
|---|---|
| Section 11- | Corner 1-Lat. 15 N, Long. 10 E; Corner 2-Lat. 15 N, Long. |
| | 45 E; Corner 3-Lat. 0 N, Long. 45 E; Corner 4-Lat. 0 N, |
| | Long. 10 E; |
| Section 12- | Corner 1-Lat. 45 N, Long. 45 W; Corner 2-Lat. 45 N, |
| | Long. 20 W; Corner 3-bat. 45 S, Long. 20 W; |
| | Corner 4-Lat. 45 S, Long. 45 W; |
| Section 14- | Corner 1-Lat. 15 N, Long. 20 W; Corner 2-Lat. 15 N, |
| | Long. 10 E; Corner 3-Lat. 45 S, Long. 10 E; |
| | Corner 4-Lat. 45 S. Long. 20 W; |
| Section 15- | Corner 1-Lat. 45 N, Long. 20 W; Corner 2-Lat. 45 N, |
| | Long. 10 E; Corner 3-Lat. 15 N, Long. 10 E; |
| | Corner 4-Lat. 15 N. Long. 20 W; |
| Section 16- | Corner 1-Lat. 0 N, Long. 10 E; Corner 2-Lat. 0 N, Long. |
| | 45 E; Corner 3-Lat. 45 S, Long. 45 E; Corner 4-Lat. 45 S, |
| | Long. 10 E; |
| Section 17- | Corner 1-Lat. 45 N, Long. 10 E; Corner 2-Lat. 45 N, Long. |
| | 45 E; Corner 3-Lat. 15 N, Long. 45 E; Corner 4-Lat. 15 N, |
| | Long. 10 E; |

Region 2 is divided into six sections of similar size; where the four corner locations of each section of Region 2 are as follows:

| | |
|---|---|
| Section 1- | Corner 1-Lat. 45 N, Long. 45 E; Corner 2-Lat. 45 N, Long. |
| | 75 E; Corner 3-Lat. 0 N, Long. 75 E; Corner 4-Lat. 0 N, |
| | Long. 45 E; |
| Section 2- | Corner 1-Lat. 45 N, Long. 75 E; Corner 2-Lat. 45 N, Long. |
| | 105 E; Corner 3-Lat. 0 N, Long. 105 E; Corner 4-Lat. 0 N, |
| | Long. 75 E; |
| Section 3- | Corner 1-Lat. 45 N, Long. 105 E; Corner 2-Lat. 45 N, Long. |
| | 135 E; Corner 3-Lat. 0 N, Long. 135 E; Corner 4-Lat. 0 N, |
| | Long. 105 E; |
| Section 4- | Corner 1-Lat. 0 N, Long. 45 E; Corner 2-Lat. 0 N, Long. |
| | 75 E; Corner 3-Lat. 45 S, Long. 75 E; Corner 4-Lat. 45 S, |
| | Long. 45 E; |
| Section 5- | Corner 1-Lat. ON, Long. 75 E; Corner 2-Lat. 0 N; Long. |
| | 105 E; Corner 3-Lat. 45 S, Long. 105 E; Corner 4-Lat. 45 S, |
| | Long. 75 E; |
| Section 6- | Corner 1-Lat. 0 N, Long. 105 E; Corner 2-Lat. 0 N, Long. |
| | 135 E; Corner 3-Lat. 45 S, Long. 135 E; Corner 4-Lat. 45 S, |
| | Long. 105 E; |

Region 3 is divided into six sections of similar size and arrangement as with Region 1.

Region 4 is divided into six sections of similar size and arrangement as with Region 2.

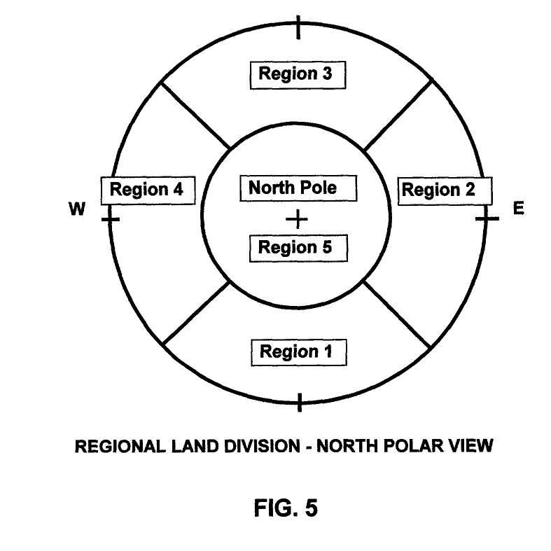

Region 5, the North Polar region, see FIG. 5, comprised of all that land extending from Lat. 45 N degrees northward to the Lunar North Pole, is divided into four sections (quadrants) of similar size; where the following indicates the corner locations of each section:

| | |
|---|---|
| Section 1- | Corner 1-(Lunar North Pole)-Lat. 90 N; |
| | Corner 2-Lat. 45 N, Long. 45 W; Corner 3-Lat. 45 N, Long. |
| | 45 E; |
| Section 2- | Corner 1-(Lunar North Pole)-Lat. 90 N; |
| | Corner 2-Lat. 45 N, Long. 45 E; Corner 3-Lat. 45 N, Long. |
| | 135 E; |
| Section 3- | Corner 1-(Lunar North Pole)-Lat. 90 N; |
| | Corner 2-Lat. 45 N, Long. 135 E; Corner 3-Lat. 45 N, Long. |
| | 225 E; |
| Section 4- | Corner 1-(Lunar North Pole)-Lat. 90 N; |
| | Corner 2-Lat. 45 N, Long. 225 E; Corner 3-Lat. 45 N, Long. |
| 315 E. | |

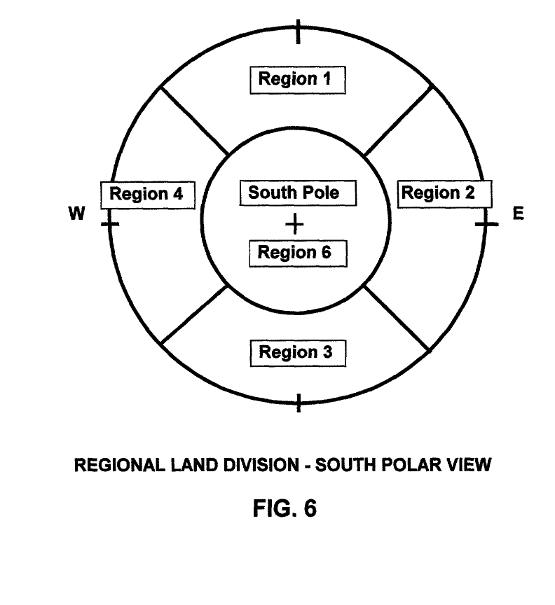

Region 6, the South Polar region, see FIG. 6, comprised of all that land extending from Lat. 45 S degrees southward to the Lunar South Pole, is divided into four sections (quadrants) of similar size; where the following indicates the corner locations of each section:

| | |
|---|---|
| Section 1- | Corner 1-(Lunar South Pole)-Lat. 90 S; |
| | Corner 2-Lat. 45 S, Long. 45 E; Corner 3-Lat. 45 S, Long. |
| | 315 E; |
| Section 2- | Corner 1-(Lunar South Pole)-Lat. 90 S; |
| | Corner 2-Lat. 45 S, Long. 135 E; Corner 3-Lat. 45 S, Long. |
| | 45 E; |
| Section 3- | Corner 1-(Lunar South Pole)-Lat. 90 S; |
| | Corner 2-Lat. 45 S, Long. 225 E; Corner 3-Lat. 45 S, 135 E; |
| Section 4- | Corner 1-(lunar South Pole)-Lat. 90 S; |
| | Corner 2-Lat. 45 S, Long. 315 E; Corner 3-Lat. 45 S, Long. |
| | 225 E; |

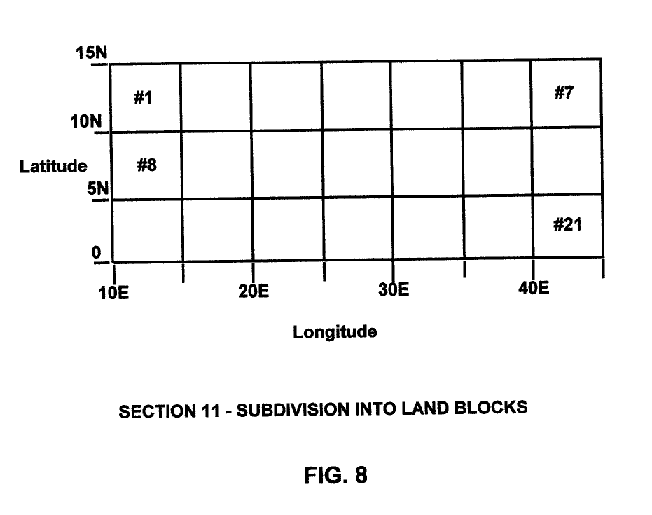

The method further includes, for Regions 1, 2, 3 and 4, the subdivision of sections into of blocks whose dimensions, in terms of latitude and longitude angular distances, are 5 degrees by 5 degrees. A method of subdivision of Section 11 of Region 1 into a multiplicity of blocks is illustrated in the drawing of FIG. 8. In this drawing, Block 17 contains the Apollo 11 Landing Site, designated A11. The particular significance of such designation is that the availability of accurate Apollo landing site location data provides a future accurate survey position reference for actual parcel siting on the lunar surface.

The method further includes, for Regions 1, 2, 3, and 4, the subdivision of the blocks into parcels whose dimensions, in terms of latitude and longitude angular distances, are 20 minutes by 20 minutes. In the case of a planetary body such as the Moon, whose diameter is approximately 2,000 miles, the choice of parcel angular dimensions in the above four lunar mid-latitude regions results in parcel linear dimensions of about 6 miles high (North-South direction) by about 6 miles wide (East-West direction) near the lunar equator. As a result of the convergence of the lines of longitude as they approach the polar terminals, the parcel dimensions in these four regions remain at about 6 miles high, but decrease in width to about 4 miles wide near Latitude 45 degrees (North or South).

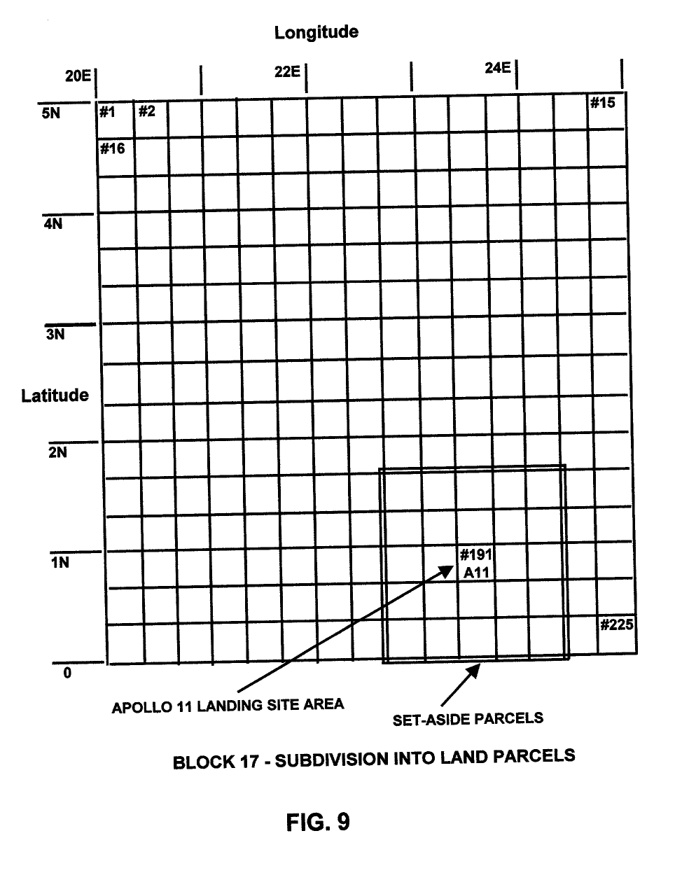

A method of subdivision of Block 17 of Section 11 of Region 1 into a multiplicity of parcels is illustrated in the drawing of FIG. 9. In this drawing, Block 17 contains the Apollo 11 Landing Site, designated All, and shown here as being located in Parcel 191. This drawing further indicates a set of parcels as potentially not being available to the public in anticipation that the U.S. Government may itself claim such an array of parcels for federal use.

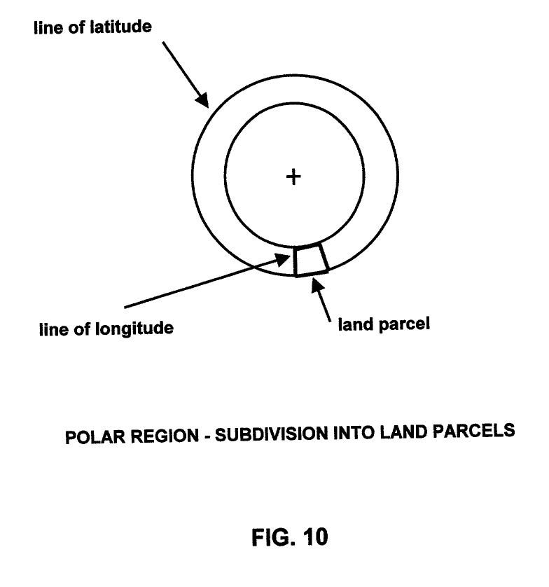

The method further includes subdivision of the sections of polar Regions 5 and 6 into parcels, see FIG. 10, wherein each parcel boundary remains, as in mid-latitude Regions 1, 2, 3, and 4, defined by lines of latitude and longitude. However, whereas the parcel height (North-South direction) remains defined as 20 minutes of delta longitude angle, i.e., about 6 miles length, the parcel angular width (East-West direction) is determined by selecting a delta latitude angle for each 90 degree annular set of parcels that results in an integral number of parcels having a width of about 6 miles. The method is applied for various sets of latitude angles between 45 N and the North Lunar Pole (for Region 5), and latitude angles between 45 S and the South Lunar Pole (for Region 6).

This size lunar parcel is used because of the level of detail of available lunar map and photographic data derived from lunar orbiting spacecraft imaging sensors. Such data offers an advantage of enabling convenient use of a personal computer and its accessory equipment to print lunar imagery of an acceptable quality and resolution, and to a scale in which a subject lunar parcel can be shown as an approximately square area of about one by one inches in printed imagery size. The availability of such quality imagery to include in a total package containing a Deed of Claim for the subject lunar land parcel would be expected to further enhance the value of the package with respect to both decorative and educational uses.

The present invention further establishes the concept of a Deed Of Claim. The Deed of Claim is an essential document element of the present invention that recognizes that, although there is no current legally acceptable basis for individual ownership of lunar property, there is a potential for such individual ownership in the form of U.S. Government Land Grants that may result as a consequence of the U.S. Government's possible future claim of lunar territories on the basis of the manned spacecraft lunar explorations and surveys accomplished by it's Apollo Lunar Space Program in the 1969-1972 time period.

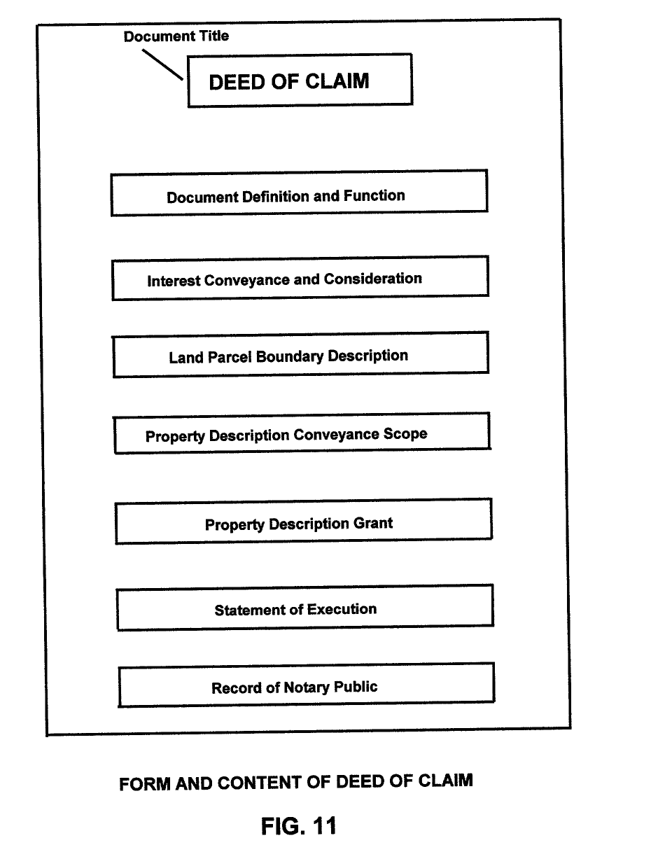

The Deed of Claim provides a basis for an individual request for the grant of a specific lunar parcel of land at such future time that the U.S. Government may conduct a land grant program. The form and content of the Deed of Claim are presented in FIG. 11.

Various illustrative examples of the present invention have been described in detail. In addition, however, many modifications and changes can be made without departing from the nature and spirit of the invention.

What is claimed is:

1. A method of compiling information about a lunar or other planetary land property on a computer readable storage medium using a computer or programmable apparatus having a processor and a memory, the method comprising:
establishing a subdivision of the planetary land property of an entire planetary globe in accordance with four decreasing element size categories: region, section, block and parcel;
defining each element by boundary lines of Longitude and Latitude, and corner locations of each element in terms of Latitude and Longitude;
establishing a concept of a Deed of Claim as a document for identifying a boundary and location of a parcel of the planetary land property and an owner of the deed;
establishing a concept wherein the document derives its value to the owner by having a utility for use as a basis for requesting the U.S. Government for ownership of the described property if and when the government chooses to claim planetary land territory and subsequently chooses to conduct a program of land grants; and
establishing a concept of a business entity which applies the compiled information to the manufacture and assembly of a documentation package for sale to parties having an interest in owning a Deed of Claim and related maps and photographs for a planetary land property, wherein such interest could be based on factors ranging from education and entertainment to potential ownership of the described planetary land property at some future time;
establishing a computer-readable database with a single database format on the computer-readable storage medium;
receiving textual information on the planetary land property;
receiving a large area image of the planetary land property;
receiving a local image of the planetary land property;
receiving at least one parameter indicating a portion of the large area image corresponding to the local area image; and
compiling the textual information, the large area image, the local area image, and the at least one parameter into the computer-readable database.

2. The method of claim 1 wherein subdivision of the lunar land property of the entire lunar globe includes the following:
division of the lunar globe into four mid-latitude regions of equal size and two polar regions of equal size; said mid-latitude regions defined as Region 1, Region 2, Region 3, and Region 4; and said polar regions defined as Region 5 and Region 6;
division of the mid-latitude regions into six sections and polar regions into four sections; and
wherein Region 1 is divided into six sections of unequal size; and
wherein each section has the specific attribute of containing within it's boundary the site of a manned spacecraft landing as part of the USA NASA Apollo Space Program in which six landings on the Moon occurred in the 1969-1972 period; and
wherein the sections are numerically identified by the contained Apollo spacecraft designation, i.e., Sections 11, 12, 14, 15, 16, and 17; and
wherein Region 2 is divided into six sections of similar size; and
wherein Region 3 is divided into six sections of similar size; and
wherein Region 4 is divided into six sections of similar size; and
wherein Region 5, the North Polar region, which is comprised of all that land extending from Latitude plus 45 degrees northward to the Lunar North Pole, is divided into four radial sections of similar size; and
wherein Region 6, the South Polar region, which is comprised of all that land extending from Latitude minus 45 degrees southward to the Lunar South Pole, is divided into four radial sections of similar size; and

3. The method of claim 1 wherein the Deed of Claim for a lunar parcel is a document that includes the following text and is constructed in general accordance with the following format:
DEED OF CLAIM
This document is a Deed of Claim, defined herewith as an accurate and precise description of the location and boundaries of a lunar land parcel. Ownership of such a deed by an individual is intended to enhance such individual's request for the described land parcel at such future time when the government of the United States of America may lay claim to a large tract of lunar land, based on its successful Apollo program of manned lunar landings and explorations, and subsequently may grant sub-divided parcels of such tract, including air space rights, land surface rights and sub-surface rights including water, mineral, oil and gas extraction rights to requesting individuals for the purpose of encouraging land development.

4. The method of claim 1 wherein the computer includes a display device, and wherein receiving textual information for the planetary land property includes:
displaying a data entry template on the display device, the data entry template containing a plurality of fields;
receiving a signal to select one of the fields; and
receiving textual data for the one of the fields.

5. The method of claim 1 wherein receiving a local area image includes receiving a plurality of local area images, wherein receiving the at least one parameter includes:
receiving a first signal to select one of the plurality of local area images;
receiving a second signal to select the portion of the large area image corresponding to the one of the local area images;
determining a plurality of coordinates which define the portion of the large area image based upon the second signal; and
wherein compiling includes compiling the plurality of local area images and the plurality of coordinates into the computer-readable database.

6. The method of claim 1 further comprising receiving a site image of at least a portion of the planetary land property, wherein compiling includes compiling the site image into the computer-readable database.

7. The method of claim 1 wherein the textual information, the large area image, the local area image, and the at least one parameter are stored as a single relational record in the computer-readable database.

8. The method of claim 1 wherein the portion of the large area image includes a framed view of the planetary land property, and wherein the local area image is of a feature of the planetary land property through the framed view.

9. The method of claim 1 wherein the information about the planetary land property is contained in a single file on the computer-readable storage medium.

10. A system for compiling information about a lunar or other planetary land property on a computer-readable storage medium using a computer or programmable apparatus having a processor and a memory, the system comprising:
means for establishing a computer-readable database with a single database format on the computer-readable storage medium;
means for receiving textual information for the planetary land property;
means for receiving a large area image of the planetary land property;
means for receiving a local area image of the planetary land property;
means for receiving at least one parameter indicating a portion of the large area image corresponding to the local area image; and
means for compiling the textual information, the large area image, the local area image, and the at least one parameter into the computer-readable database.

11. The system of claim 10 wherein the computer includes a display device, and wherein the means for receiving textual information for the planetary land property includes:
means for displaying a data entry template on the display device, the data entry template containing a plurality of fields;
means for receiving a signal to select one of the fields; and
means for receiving textual data for the one of the fields.

12. The system of claim 10 wherein the means for receiving a local area image receives a plurality of local area images, and wherein the means for receiving the at least one parameter includes:
means for receiving a first signal to select one of the plurality of local area images;
means for receiving a second signal to select the portion of the large area image corresponding to one of the local area images; and
means for determining a plurality of coordinates which define the portion of the large area image based upon the second signal;
wherein the means for compiling compiles the plurality of local area images and the plurality of coordinates into the computer-readable database.

13. The system of claim 10 further comprising means for receiving a site plan image of at least a portion of the planetary land property, wherein the means for compiling compiles the site plan image into the computer-readable database.

14. The system of claim 10 wherein the textual information, the large area image, the local area image, and the at least one parameter are stored as a single relational record in the computer-readable database.

15. The system of claim 10 wherein the portion of the large area image includes a framed view of the planetary land property, and wherein the local area image is of a feature of the planetary land property through the framed view.

16. The system of claim 10 wherein the information about the planetary land property is contained in a single file on the computer-readable storage medium.

17. A method of doing business, comprising operations of:
developing, producing, assembling, and offering for sale a documentation package covering a lunar land property parcel;
wherein the package includes decorative and educational imagery related to the parcel, and further, includes a document herein defined as a Deed of Claim for the parcel;
wherein, the primary function of the deed, and so stated in the deed's contents, is to provide an accurate and detailed description of the location and boundary of the parcel, and not to indicate any legal ownership of the parcel;
wherein, the land containing the parcel has been subject to the Apollo Lunar Space Program of exploration and survey conducted by the U.S. Government during the 1960's and 1970's, and
wherein, the value of the deed is to be based on the possibility that, at some future time, the U.S. Government may choose to claim some part or all of Earth's Moon, and as a consequence, may choose to encourage lunar development by establishing a land grant program;
wherein, as a further consequence, the government may choose to recognize a land grant claimant's ownership of the Deed of Claim for a specific land parcel as an essential element of the claimants request for the specific land parcel;
developing a plan of subdivision of the lunar globe into a decreasing size sequence of regions, sections, blocks and parcels;
wherein, subdivision of the lunar globe results in four equally sized mid-latitude regions and two equally sized polar regions, said mid-latitude regions defined as Region 1, Region 2, Region 3 and Region 4, and said polar regions defined as Region 5 and Region 6;
wherein, a first mid-latitude Region 1 is centered on the equatorial center of the lunar near side, has longitudinal and latitudinal dimensions of 90 degrees, and the remaining three mid-latitude Regions 2, 3 and 4 are similarly constructed with center longitudinal spacings of 90 degrees; and where Polar Region 5 contains all that land from North 45 Degrees Latitude to the Lunar North Pole; and where Polar Region 6 contains all that land from South 45 Degrees Latitude to the Lunar South Pole;
wherein, Region 1 has the singular quality of containing the 6 Apollo landing sites within its boundary and is accordingly subdivided into 6 sections, each bounded by pairs of longitude and latitude lines, and containing one of the landing sites, with the result that the sections are not necessarily of equal size;
wherein, Regions 2, 3, and 4 are each subdivided into 6 sections, three above and three below the lunar equator, each section equally bounded by pairs of 30 degree-spaced lines of longitude and 45 degree-spaced lines of latitude;
wherein, Polar Regions 5 and 6 are each subdivided into 4 radial sections, each section equally bounded by pairs of 90 degree-spaced lines of longitude and 45 degree-spaced lines of latitude;
wherein, the sections of Regions 1, 2, 3, and 4 are each subdivided into a multiplicity of blocks whose latitude and longitude dimensions are 5 degrees;
wherein, the blocks contained in the sections of Regions 1, 2, 3, and 4 are each subdivided into a multiplicity of land property parcels whose latitudinal and longitudinal dimensions are ⅓ degree each, whereby such dimensions correspond to a nominal linear value in the range of about 6 miles by 6 miles in the mid-latitude regions of the moon;
wherein, the sections of Polar Regions 5 and 6 are each subdivided into 6 blocks of approximately equal size, each block bounded by pairs of 15 degree-spaced-lines of longitude and 45 degree-spaced-lines of latitude;
wherein, the blocks contained in the sections of Polar Regions 5 and 6 are each subdivided into land property parcels whose latitudinal dimension is ⅓ degree, corresponding to a linear value of about 6 miles;
wherein, the longitudinal angular dimension of a desirably square parcel will vary with the latitude location of a parcel in order to compensate for the decreasing linear separation of the lines of longitude as they converge towards the lunar poles;
wherein, a calculation is made to determine what integer value of parcel longitudinal dimension, in terms of degrees and/or minutes of angle, results in an integer number of parcels having a linear width of the order of 4 to 6 miles;
establishing the use of map and photographic imagery, in paper and/or digital electronic form, as part of the documentation package, that have been determined to be publicly available from the U.S. Government;
wherein, such imagery is used to develop the imagery content of a documentation package;
wherein, such imagery content includes three pairs of map and photograph of similar size and intended to be suitable for framing; with imagery scaled in accordance with a sequence which provides a lunar global view and a large area view indicating the general location of the lunar land parcel, and a local area view indicating, in more detail, the location and boundary of the lunar land parcel;
establishing a computer-useable database, herein defined as a Master Map and Chart Set of the Lunar Tract, of all parcel locations, as determined from lunar subdivision into the area sequence of regions, sections, blocks, and parcels;
establishing an inventory of individual lunar parcels, to be drawn from the above parcel locations database;
wherein, for each parcel, a documentation package containing the Deed of Claim and its associated location-oriented imagery is developed, and assembled in paper or computer disc format;
establishing the offering for sale of a documentation package for individual lunar parcels;
establishing a computer-useable registry, defined herein as the Lunar Claim Registry, whose uses will include that of maintaining a record of original ownership of a Deed of Claim, and any subsequent ownership of the deed where such information is made available to the registry operator;
establishing the use of copyright protection of the Lunar Claim Registry, with its Deed of Claim ownership data contents, as a method for achieving data storage in the U.S. Archives;
establishing an organization of members, in the form, for example, of a Lunar Claim Society, whose focus is the provision of information of common interest to Deed of Claim owners;
wherein, the organization functions include periodic generation of a newsletter, primarily internet-based, to provide information of potential interest to society members and other readers.

18. The method of doing business of claim 17, wherein the comprised operations are applied to a Martian or any other planetary land property parcel where such planetary land has been subject to a program of exploration and survey by the U.S. Government.
